(19) United States
(12) Patent Application Publication
(10) Pub. No.: US 2009/0126606 A1
(43) Pub. Date: May 21, 2009

(54) Secure enclosure

(75) Inventor: Dennis Flood, Dundee (GB)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/986,268

(22) Filed: Nov. 20, 2007

(51) Int. Cl. E05G 1/026

(52) U.S. Cl. 109/27

(57) ABSTRACT

A secure enclosure for resisting attacks using explosives. The secure enclosure has a body defining an opening and a door leaf hingeably coupled to the body for securely closing the opening. The body and door leaf define a cavity in which valuable items may be stored. The secure enclosure also defines a plurality of frangible portions. Each frangible portion comprises a weakened perimeter so that the frangible portions are ejected by the rapid build-up of pressure when an explosion occurs within the secure enclosure, thereby reducing the pressure within the secure enclosure and preserving the integrity of the body and door.

### BACKGROUND

The present invention relates to improvements in or relating to a secure enclosure.

Secure enclosures, such as safes, strongrooms, and vaults, are typically used to store valuable items. One particular application of secure enclosures is to house valuable components of an automated teller machine (ATM), such as a cash dispenser, a cash acceptance module, and the like. The value of such components is principally derived from the large amounts of cash stored within them.

Secure enclosures provided in ATMs (hereinafter “ATM safes”) differ from conventional safes in that ATM safes include apertures. These apertures may be in the form of slots through which media items (such as banknotes) enter and exit a cash dispenser in the ATM safe, and holes through which control cables pass from the cash dispenser to an ATM controller. The ATM safe has to be designed so that these apertures do not compromise the security of the ATM safe. This is typically achieved by strengthening areas around the apertures, for example, with additional areas of steel.

ATM safes are designed to resist attack from many different types of tools, such as sledgehammers, power drills, and thermal cutting tools. However, it is becoming more common for ATM safes to be subjected to attacks from explosives, such as plastic explosives, or explosive gas (for example, oxyacetylene or butane gas). In a typical attack, an ATM aperture is created or accessed, for example by drilling or cutting through a thin shutter covering an existing aperture, such as a cash dispense slot. The explosive substance (solid or gas) is inserted into the ATM through this aperture then detonated.

ATM safes can be designed to withstand explosive attacks by strengthening the ATM safe door and the internal corners of the ATM safe. However, explosion-resistant ATMs typically cost several times the price of a similar safe which does not resist an explosive attack.

It would be advantageous to be able to provide a low cost safe that is resistant to both conventional attacks (from power tools, sledgehammers, and the like) and attacks using explosives.

### SUMMARY

According to a first aspect of the present invention there is provided a secure enclosure comprising: a body defining an opening; and a door leaf hingeably coupled to the body for securely closing the opening; the secure enclosure defining a plurality of frangible portions, each frangible portion comprising a weakened perimeter such that the frangible portions are ejected in the event of an explosion occurring within the secure enclosure.

By virtue of this aspect of the present invention the frangible portions act as valves to relieve the near-instantaneous pressure build-up resulting from an explosion within the enclosure.

The frangible portions are preferably provided in the body but may also be provided in the door leaf.

The body may comprise support walls having a composite construction. Alternatively, the body may comprise a single material, such as steel.

The composite construction may comprise a central material sandwiched between two layers (an external layer on an outer surface of the central material and an internal layer on an inner surface of the central material). The central material may comprise steel, high density concrete, or the like. In one embodiment, the central material comprises high density concrete incorporating a first set of parallel, spaced, rods aligned in a first direction, and a second set of parallel, spaced, rods aligned transverse to the first direction. Other conventional components may be included to improve resistance of the body to attack, for example, fragments of metal may be incorporated into the central material.

The external layer and the internal layer may be thin relative to the thickness of the central material.

In embodiments in which the support walls are formed from a single material (such as steel), the frangible portions may be approximately the same depth as the support walls.

In embodiments in which the support walls have a composite construction of multiple layers, the frangible portions may be approximately the same depth as one of the layers, such as the external layer. Alternatively, the frangible portions may also have a composite construction (typically different to the composite construction of the support walls) and may be approximately the same depth as the support walls.

Each frangible portion may comprise a portion of the external layer having a weakened perimeter in registration with an aperture defined by the central material.

The aperture defined by the central material may be filled with a solid material that is lightweight relative to the central material. This would make it more difficult to detect the location of frangible portions by tapping the external or internal layers to detect a hollow sound.

In some embodiments, although not preferred, each frangible portion may further comprise a portion of the internal layer having a weakened perimeter in registration with both the weakened perimeter of the external layer and the aperture defined by the central material.

Each weakened perimeter may include a continuous line of reduced thickness, a broken line of reduced thickness, or a perforated line (that is, a discontinuous broken line). The external layer and/or the internal layer may have a coating (plaster (such as polyfilla (trade mark)), plastics, paint, or the like) to provide an aesthetic finish. The coating may cover the weakened perimeters so that the frangible portions are not visible.

In embodiments in which the weakened perimeter comprises a line of reduced thickness (but not perforations), the weakened perimeter may be provided on an inner surface of the external layer (that is, a surface of the external layer closest to the inside of the enclosure) so that it is not visible from outside the enclosure.

In any embodiments in which a portion of the internal layer has a weakened perimeter in registration with both the weakened perimeter of the external layer and the aperture defined by the central material, the weakened perimeter may be provided on an inner surface of the internal layer (that is, a surface of the internal layer closest to the central material) so that it is not visible from inside the enclosure.

Each frangible portion may have a depth less than or approximately equal to the depth of the support walls, and at least one other dimension (height or width) less than approximately 70 mm to ensure that it is not vulnerable to a conventional attack, and to maintain a reasonable probability of passing an international standard for security of safes, such as EN1143.

### BRIEF DESCRIPTION OF THE DRAWINGS

This and other aspects of the present invention will be apparent from the following specific description, given by way of example, with reference to the accompanying drawings, in which:

FIG. 1 is a schematic perspective view of a secure enclosure according to one embodiment of the present invention;

FIG. 2 is a front view of the secure enclosure of FIG. 1;

FIG. 3 is a sectional diagram of part (a portion of a support wall) of the secure enclosure of FIG. 1;

FIG. 4 is a sectional diagram of another part (a frangible portion) of the secure enclosure of FIG. 1;

FIG. 5 is a front view of the frangible portion of FIG. 4; and

FIG. 6 is a pictorial perspective view of the secure enclosure of FIG. 1 immediately after an explosive attack.

### DETAILED DESCRIPTION

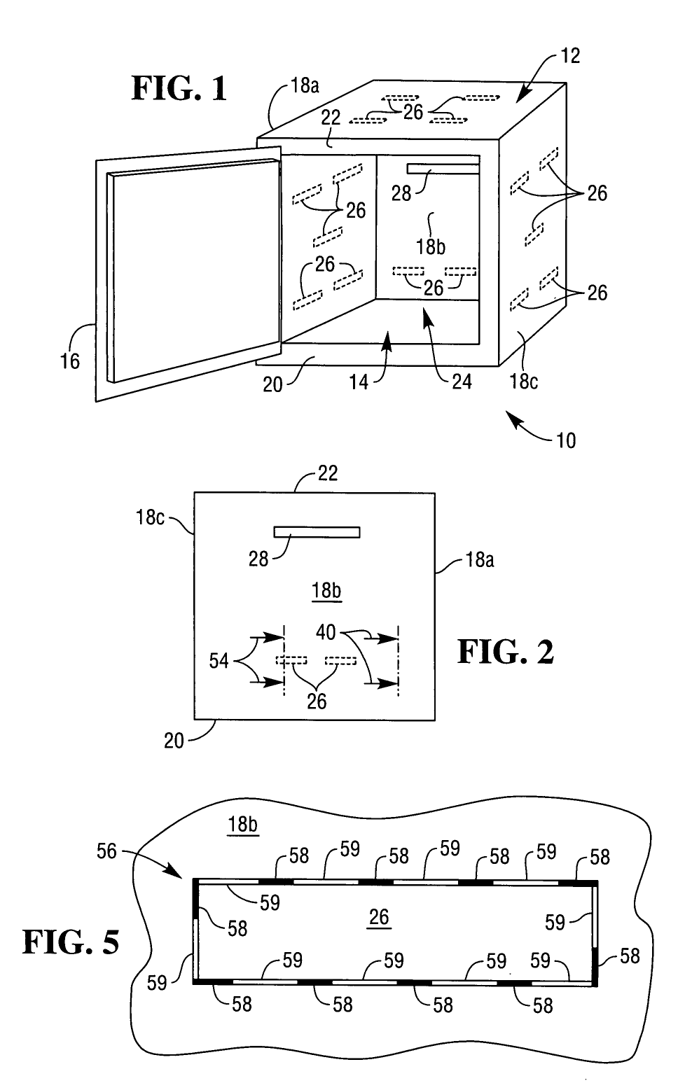

Reference is first made to FIG. 1, which is a schematic perspective view of a secure enclosure 10, in the form of an ATM safe, according to one embodiment of the present invention. The ATM safe 10 is designed for use in a rear access ATM and comprises a body 12 defining an opening 14 at the rear of the body 12, and a door leaf 16 hingeably coupled to the body 12 for securely closing the opening 14.

A handle (not shown in FIG. 1), a lock (not shown), and engagement bars (not shown) are mounted onto the door leaf 16 to allow the door leaf 16 to be opened and securely closed. The handle, lock, and engagement bars are of the type conventionally used on ATM safes.

The body 12 comprises three support walls 18a,b,c, upstanding from a base 20 to a roof 22, so that the body 12 defines a cavity 24 in which an ATM cash dispenser (not shown) can be located.

The support walls 18 and the roof 22 define frangible portions 26 (shown in broken line in FIG. 1). These frangible portions 26 will be described in more detail below.

In the same manner as for a conventional ATM safe, a cash dispenser mounted in the body 12 has a shutter (not shown) that aligns with an aperture 28 defined by the front support wall 18b. Under control of the cash dispenser (not shown), the shutter (not shown) opens and closes the cash dispenser aperture 28.

Reference will now also be made to FIG. 2, which is a front view of the ATM safe 10 showing the cash dispenser aperture 28, which is a slot having a width of approximately 300 mm and a height of approximately 65 mm.

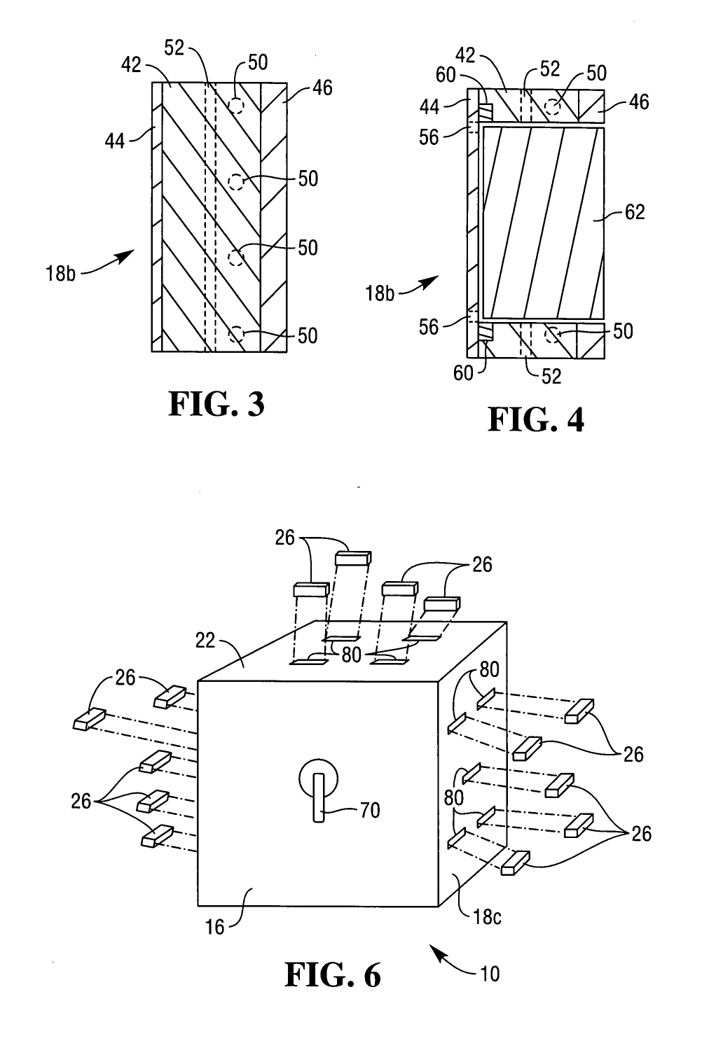

Reference will now also be made to FIG. 3, which is a sectional view of a portion of the front support wall 18b, illustrated by arrows labeled 40 in FIG. 2. In FIG. 3, the support wall 18b has a composite construction comprising: a central material 42 sandwiched between an external layer 44 on an outer surface of the central material 42 and an internal layer 46 on an inner surface of the central material 42. The internal layer 46 is adjacent the cavity 24 (FIG. 1).

The central material 42 comprises high density concrete incorporating a first set of parallel, spaced, steel rods 50 aligned parallel to the base 20, and a second set of parallel, spaced, steel rods 52 aligned perpendicular to the base 20. In this embodiment, the central material 42 is approximately 35 mm thick, the external layer 44 is mild steel approximately 2 mm thick, and the internal layer 46 is stainless steel approximately 3 mm thick. The steel rods 50,52 are each approximately 8 mm in diameter.

Reference will now also be made to FIG. 4, which is a sectional diagram of a portion of the front wall 18b including one of the frangible portions 26, illustrated by arrows labeled 54 in FIG. 2. In this embodiment, every frangible portion 26 has an identical depth, width, and height.

The frangible portion 26 comprises a weakened perimeter 56 (best seen in FIG. 5) in the form of a series of perforations. The weakened perimeter 56 is a rectangle measuring approximately 200 mm wide and approximately 60 mm high, and comprises a series of anchors 58 measuring 1 mm high and 10 mm wide defined by adjacent slots 59 measuring 1 mm high and 20 mm wide.

In the areas of the support walls 18 around the frangible portions 26, the central material 42 is reinforced by additional steel frames 60. This is to ensure that the areas of support walls 18 adjacent to frangible portions 26 are more resistant to attack than other areas of the support walls 18.

In FIG. 4, the central material 42 defines a central aperture (not shown) in registration with the weakened perimeter 56. To ensure that this frangible portion 26 does not sound hollow if tapped by a finger or a tool, a lightweight block 62, such as a polystyrene or wooden block, is mounted within the central aperture and maintained in position by a loose interference fit.

To provide an aesthetic finish, and to mask the locations of the frangible portions 26, a surface finish, such as polyfilla (trade mark), may be applied to the external layer 44 to fill in the slots 59 of the weakened perimeters 56. A surface finish may also be applied to the internal layer 46 (including the lightweight block 62).

The frangible portion 26 may be considered as (i) only the part of the external layer 44 within the weakened perimeter 56, or (ii) that part of the external layer 44 within the weakened perimeter 56 in combination with the lightweight block 62.

The operation of the ATM safe 10 will now be described with reference to FIG. 6, which is a pictorial perspective view of the ATM safe 10 immediately after an explosive has been detonated within the ATM safe 10. FIG. 6 is a rear view of the ATM safe 10, and illustrates the door leaf 16 having a door handle 70 in the closed and locked position to secure the contents of the ATM safe 10.

When an explosive is detonated within the ATM safe 10 there is a near-instantaneous build up of pressure in the cavity 24 (FIG. 1). This pressure build up pushes the support walls 18 outwards, and causes the anchors 58 to sheer from the support walls 18, thereby ejecting the frangible portions 26 from the ATM safe 10, as illustrated in FIG. 6.

Once the frangible portions 26 have sheered from the support walls 18, the pressure build up is released because air can escape from the cavity 24 (FIG. 1) through newly-created apertures 80 corresponding to areas of the support walls 18 or roof 22 where the frangible portions 26 were located; that is, the newly-created apertures 80 correspond to the area enclosed by the weakened perimeters 56 and the central apertures (not shown). By allowing the pressure in the cavity 24 to be released through the newly-created apertures 80, the support walls 18 maintain their integrity, and the ATM safe 10 remains secure.

Various modifications may be made to the above described embodiment within the scope of the invention, for example, in other embodiments, the frangible portions may have different sizes, and different locations than shown in the above embodiment. In other embodiments, there may be a different number of frangible portions. The number of frangible portions may depend on the volume and design of the secure enclosure. In the above embodiment, every frangible portion has an identical depth, width, and height; whereas, in other embodiments, different sizes of frangible portions may be provided in a secure enclosure. In other embodiments, the shape of the frangible portions may be different to that shown in the above embodiment, for example, the shape may be round, triangular, or irregular (non-geometric).

In other embodiments, instead of using perforations to provide a weakened perimeter, the external layer 44 may have a reduced in thickness across an area defining a frangible portion 26. In still other embodiments, the external layer 44 may have a reduced thickness only at the perimeter (not the center) of a frangible portion 26.

In other embodiments the support walls may not have a composite construction, they may comprise a single type of material, such as steel. In such embodiments, each frangible portion may comprise an area defined by a reduced thickness perimeter line, a reduced thickness area, or a perforated line.

In other embodiments, a secure enclosure other than an ATM safe may be provided, for example, a vault having no apertures, or only one aperture for a key.

What is claimed is:

1. A secure enclosure comprising:
a body defining an opening; and
a door leaf hingeably coupled to the body for securely closing the opening;
the secure enclosure defining a plurality of frangible portions, each frangible portion comprising a weakened perimeter such that the frangible portions are ejected in the event of an explosion occurring within the secure enclosure.

2. A secure enclosure according to claim 1, wherein the frangible portions are provided in the body and the door leaf.

3. A secure enclosure according to claim 1, wherein the body comprises support walls having a composite construction including a central material sandwiched between an internal layer and an external layer.

4. A secure enclosure according to claim 3, wherein each frangible portion comprises a portion of the external layer having a weakened perimeter in registration with an aperture defined by the central material.

5. A secure enclosure according to claim 4, wherein each frangible portion further comprises a portion of the internal layer having a weakened perimeter in registration with both the weakened perimeter of the external layer and the aperture defined by the central material.

6. A secure enclosure according to claim 4, wherein the aperture defined by the central material is filled with a solid material that is lightweight relative to the central material.

7. A secure enclosure according to claim 4, wherein each weakened perimeter includes a continuous line of reduced thickness.

8. A secure enclosure according to claim 4, wherein each weakened perimeter includes a broken line of reduced thickness.

9. A secure enclosure according to claim 4, wherein each weakened perimeter includes a perforated line.

10. A secure enclosure according to claim 9, wherein the external layer has a coating to cover the perforated lines so that the frangible portions are not visible.

11. A secure enclosure according to claim 4, wherein each frangible portion has a thickness approximately equal to the thickness of the support walls, and at least one other dimension less than 65 mm to ensure that it is not vulnerable to a conventional attack.
